(19) United States
(12) Patent Application Publication
(10) Pub. No.: US 2015/0012335 A1
(43) Pub. Date: Jan. 8, 2015

(54) AUTOMATED RENTAL AMOUNT MODELING AND PREDICTION

(71) Applicant: CORELOGIC SOLUTIONS, LLC, Irvine, CA (US)

(72) Inventors: Jianjun Xie, Irvine, CA (US); Matthias Blume, Irvine, CA (US)

(21) Appl. No.: 14/493,166

(22) Filed: Sep. 22, 2014

Related U.S. Application Data
(63) Continuation of application No. 13/791,034, filed on Mar. 8, 2013.

(51) Int. Cl. G06Q 10/06; G06Q 50/16

(52) U.S. Cl. CPC G06Q 10/067; G06Q 50/16
USPC 705/7.31

(57) ABSTRACT

Disclosed systems and methods can determine predicted rental income, estimated error of the prediction, and a set of comparable rental real estate properties for use in the valuation of a subject real estate property rental value. In one embodiment, the rent prediction system receives rental information about real-estate properties, determines feature characteristics, trains a rent amount prediction model using the feature characteristics, determines a second set of feature characteristics based on the output of the rent amount prediction model, and trains an error prediction model using the determined second set of feature characteristics. Using the trained models, the systems and method may predict a rental value and prediction error for one or more subject properties.

### CROSS-REFERENCE TO RELATED APPLICATIONS

The present application is a continuation of U.S. patent application Ser. No. 13/791,034, filed Mar. 8, 2013, titled “AUTOMATED RENTAL AMOUNT MODELING AND PREDICTION,” which is hereby incorporated by reference herein in its entirety.

### BACKGROUND

1. Field

The present disclosure relates to computer processes for predicting rental income for a real estate property.

2. Description of Related Art

To determine an estimated rental income for a real estate property (e.g., a fair market value for rental income), real estate professionals can analyze recent rentals and sales of properties that have characteristics (e.g., size, style, age, location, etc.) that are comparable to the subject real estate property. The rental and sales prices of such comparable properties (often called “comps”) can be good indicators of the rental income for the subject real estate property. However, property rental income predictions made by real estate professionals are subject to the qualifications, experience, and biases of the real estate professional and can take significant time to prepare. Additionally, the use of a real estate professional to apply a comps based model involves a large lag time between the rental inquiry and a returned prediction of rental value.

Besides reliance on real estate professions, industry standard “comps” based models have other disadvantages. First, a comps based model performs poorly when no or few comparable properties can be found. For example, homes in rural areas or unique homes that are unlike others in a geographic area are difficult to value using a comps based model. Drawing any rental conclusions for these types of properties using a “comps” based model introduces a high amount of inaccuracy in the prediction. Second, a comps based model assumes the rent price of a specific property will be affected by property location, physical attributes, and the current time national and local economic environment. Thus, a comps based model requires very strong data accuracy and data density to reduce the error in a comps based prediction. However, because entry of rental property data into searchable database is a manual process, real estate databases are prone to occasional keyboard entry and input errors. If a single variable in a selected comp is incorrect, the comps based estimate of rent may be greatly affected.

Automated models that can provide an automated rental income prediction for a property do exist. Unlike the manual comps based model, these models quickly determine results and do not require a real estate professional.

### SUMMARY

A purely comps based rental value estimator is generally unable to take into account current market trends, or make accurate estimates about properties with few comparable properties. The present disclosure provides examples of automated systems and methods that can estimate the rental price using current market trend information. Data regarding local comparables may, but need not, additionally be used.

In one aspect, a method for predicting the fair market rent price of a subject property is provided. The method comprises receiving rental information about a plurality of real-estate properties within a geographic region, the information comprising at least a location and a rent amount associated with each real-estate property. The method further includes determining feature characteristics based on the received rental information, and training a rent amount prediction model using the feature characteristics to minimize a loss function associated with a prediction of rental price. The method further includes determining a second set of feature characteristics based on the received rental information and the output of a rent amount prediction model, and training an error prediction model using the second set of feature characteristics to minimize a loss function associated with the error in the rent amount prediction model. The method also includes receiving information about the subject property and determining, for this property, an estimated rent amount based on the received information about the subject property and the rent amount prediction model, and an estimated measurement of the error of the estimated rent amount based on the estimated rent amount and the error prediction model.

In another aspect, a system for predicting a rental value of a subject property is disclosed. The system comprises a computer system comprising one or more computers, said computer system configured to at least access one or more first data repositories to obtain rental information associated with a plurality of properties dispersed over a first geographic area, the rental information comprising at least a rent amount associated with each property in the plurality of properties. The system can further be configured to access one or more second data repositories to obtain economic trend information, wherein the economic trend information summarizes real property characteristics over a plurality of geographic areas within the first geographic area. The system can also be configured to process the rental information to determine feature characteristics of one or more properties within the plurality of properties, wherein at least one or more of the feature characteristics comprise a combination of economic trend information associated with a summary rent amount calculated from the rental information. These feature characteristics allow the system to be configured to train a mathematical model based on these feature characteristics. The mathematical model can then, based on inputs associated with the subject property, produce a rental prediction about the subject property.

Details of one or more implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 is a block diagram that schematically illustrates an example of a system to automatically predict and model rental value of real estate.

FIG. 2 is a flowchart that illustrates an example of a method for creating a rental income model to predict rental income for rental properties.

FIG. 3 is a flowchart illustrating some embodiments that use a rental income model to predict rental income for one or more subject properties.

FIG. 4 is a flowchart illustrating some embodiments that use a comps based model as at least one predictor of rental income for one or more subject properties.

FIG. 5 is a data diagram illustrating some embodiments summarized rental information that can be used as feature characteristics.

### DETAILED DESCRIPTION OF SPECIFIC EMBODIMENTS

Computer-based systems and methods are disclosed for modeling and predicting rental amounts for real estate properties. In some embodiments, the systems and methods improve predictions of fair market rental prices by combining localized history rent market features with other economic features like vacancy rates and property sales trends. In some embodiments, prediction accuracy may be improved by using a comps based model combined with a non-local rental feature model that includes statewide or national rentals for comparison. In some embodiments, a confidence score and/or rental error rate, such as a forecast standard deviation (“FSD”) may be calculated to provide information about the relative error rate inherent in any market prediction.

Implementations of the disclosed systems and methods will be described in the context of determining and/or predicting rental income value, determining confidence score(s), determining the standard deviation for such prediction(s), and finding comparable rental properties to residential real estate properties such as homes (e.g., single-family homes, multi-family dwellings, etc.), condominiums, townhouses or town homes, and so forth. This is for purposes of illustration and is not a limitation. For example, implementations of the disclosed systems and methods can be used to find comparable properties to commercial property developments such as office complexes, industrial or warehouse complexes, retail and shopping centers, and apartment rental complexes. In addition, although the determined rental predictions and comparable properties found by various implementations of the systems and methods described herein can be used by rent amount models (RAMs) to provide automated rental income valuations, the comparable properties can also be provided to and used by real estate brokers, real estate appraisers, and the like to perform manual rental income valuations of a subject property.

### Overview

In some embodiments, a rent amount model (RAM) may be configured to automatically estimate the monthly rent that can be obtained for a particular residential property, a confidence level on that estimate, and a set of comparable properties (comps) that provide justification for the rent estimate. Complex statistical models, such RAMs, often require large data sets that can be used to draw similarities and correlations across records using mathematical models in order to make predictions. This process is often called “training” a model. Here, large data sets of local, statewide, or even national rental listings and transactions data may be obtained from various data sources, smoothed or summarized, and used to train a model to predict what kind of rental payments real estate properties may yield in the future. Other non-rental related data about a property not traditionally used in making rent value predictions may be included in order to make the model more accurate. For example, in some embodiments, vacancy rate models (VRMs), expected resident risk (ERR), property tax estimate, and/or HPI forecasts, among others, may be included. Together, these components may provide the information needed to optimize decisions around buying and selling residential properties for rental income.

For example, using the computerized models described herein, savvy investors may be able to bid for residential properties for sale at auction more accurately than their competitors. Similarly, developers could make an investment screening app that allows the user to filter an entire stock of properties for sale to find units that meet specific rental criteria. In addition, using the computerized models describe herein, lenders or mortgage-backed security investors may make better disposition decisions for distressed properties, where one possible decision is to hold the property for rental income. The company implementing such a model may sell the computerized model's prediction and report directly for example using a web interface, sell a decision support tool that utilizes the computerized model, and/or sell “Rental Trends” tables of average rent amounts by geographic area and property type.

There are two categories of data consumed by RAMs disclosed herein. The first category is actual records of properties for rent (or already rented). This may include the type of property (single family home, condo, etc.), the asking price or agreed upon rent price, and some characteristics that describe the property (beds, baths, sq. ft., etc.). These types of data sources can be found online. For example, multiple listing services (MLSs) contain data intended for realtors to use to match land lords to renters, and can be contacted and queried through a network such as the Internet. Such data may then be downloaded for use by the RAM. Other examples include retrieving data from databases/websites such as Craigslist that allow users to directly post about available rentals.

A second category of data (i.e. secondary data sources) may include auxiliary data sources that are not rental listings, but are instead local economic features associated with a particular region that a rental property resides in, or some other characteristic about the property not found in rental listings. Such data sources may include, HUD 50% or 40% rents, income levels, and vacancy rates at the ZIP code, county, core based statistical area defined by the government (CBSA), and/or state level among others. Utilizing these secondary data sources in conjunction with “smart” geographic smoothing of the primary data provides 100% coverage of the United States. Unlike the prior art, the model can predict a rent amount for any property, even in areas with few or no comps.

Three distinct methods of modeling rent amounts are discussed in this application: smoothing, a national model, and a comps model. Although each model may be used individually, each model may also be combined with the other models in order to improve prediction accuracy. In addition, the outputs of one model may become the inputs for another model. For example, after performing “smoothing” on input rental data, the national model may use the smoothed model's data for training or as an input during a subject property prediction. Another example of how the models can be combined is through weighted averaging. For example, the national model and the comps-based model can be combined by weighted averaging, where the weights are determined from the forecast standard deviations of each model for that subject property.

The national model may be built using machine learning techniques for solving regression problems, including techniques to minimize loss functions. In some embodiments, the national model may comprise a gradient boosting regression trees algorithm which offers a low median absolute error compared to the prior art.

It is also advantageous to be able to predict the error rate of any prediction made by the national model, or any other RAM. A Forecast Standard Deviation (FSD) estimate based on a similar regression model, for example a gradient boosting regression trees algorithm, may be prepared using a calibration curve. Advantageously, this is a completely data-driven approach for calculating property level FSD values that are correctly scaled (e.g., 68% of the RAM's predictions lie within one FSD of the actual rent amount). Furthermore, this type of error model is applicable to measuring the error rate of other predictive models, for example a model that predicts the sell value of a real-estate property.

### Example Real Estate Property Valuation System

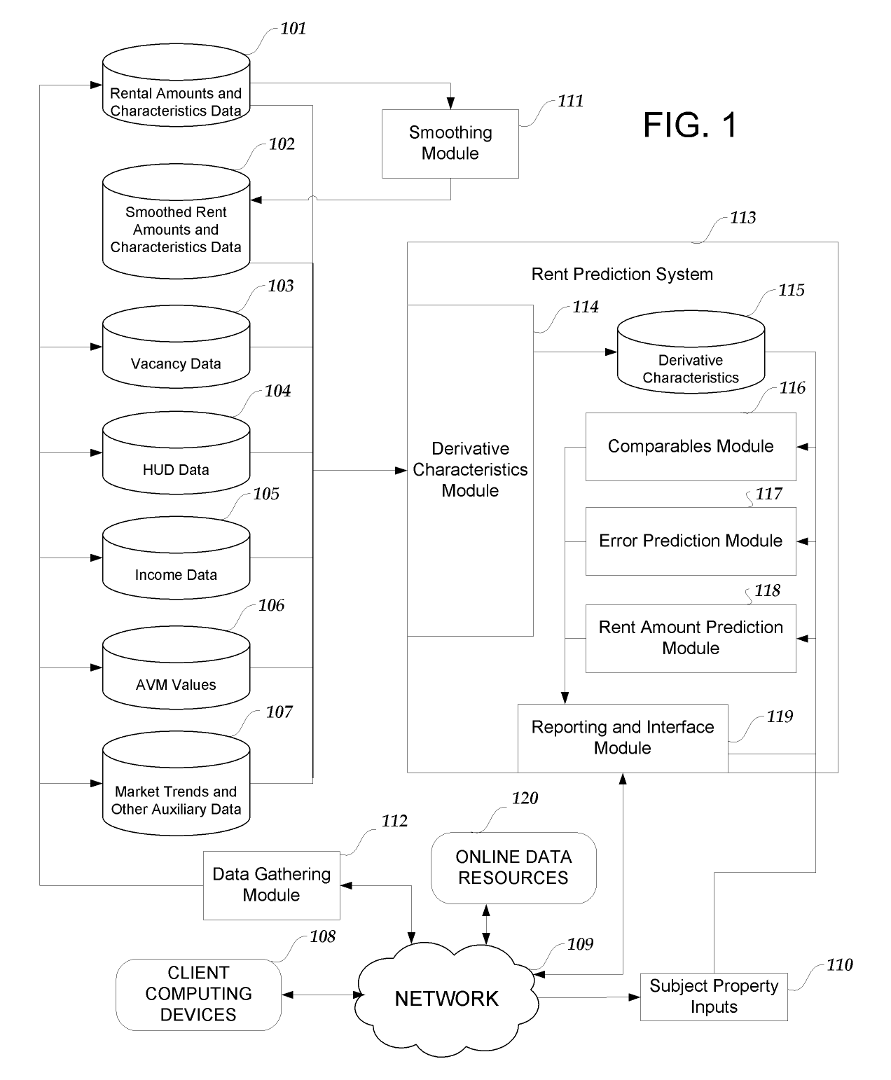

FIG. 1 illustrates one embodiment of a computer-based system for predicting or determining rental income for one or more rental properties. The rent prediction system 113 may include either together or separately, but is not limited to, a derivative characteristics module 114, a derivative characteristics database 115, a comparables module 116 implementing a comps based model, an error prediction module 117, a rent amount prediction module 118 implementing a national, loss function based model, and a reporting and interface module 119. Rent prediction system 113 may also include, or send to or receive data from, or otherwise electronically interact with, a variety of other computing devices and/or databases, including databases containing rental amounts and characteristics of properties 101, smoothed rent amounts and characteristics 102, a smoothing module 111, geographic vacancy data 103, The Department of Housing and Urban Development data 104, geographic data about income distribution, property sales data and/or real estate sale price models (also known as automated valuation models, AVMs) 106, data gathering modules 112, consumer client computing devices 108, or other online data resources 120.

### Data Gathering Module

The data gathering module 112, retrieves rent or related auxiliary data (or any other data possibly correlated with rental value), from network connected online servers, to store in one or more of databases 101-107.

For example, in some embodiments, the data gathering module downloads direct rent transaction data that is useful for training the rent prediction system 113 to predict accurate rental value results. A multiple listing service (MLS) may be electronically contacted to request transmission of MLS rental transaction information to the data gathering module (or directly to one of the databases 101-107). An MLS is a suite of services that operates as a facility for the orderly correlation and dissemination of real estate listing information. A MLS's database and software is typically used by real estate brokers in real estate, representing sellers under a listing contract to widely share information about properties with other brokers who may represent potential buyers or wish to cooperate with a seller's broker in finding a buyer for the property or asset. MLS listings also typically contain not only on sale properties, but properties that are available for rent, including a list rent amount. Although these database are often private, MLS's can often sell electronic access to their proprietary information.

The data gathering module can, on a weekly (or monthly, quarterly, etc.) basis download and aggregate the MLS rental listing information for use in finding comparative properties or training either the national or error predictive models. The downloaded information may include the property type (single family, condos, townhome, multifamily, apartment, etc.), an associated rental amount (which could be a list rent price, or an actual agreed to list price), and various characteristics of the property, including, but not limited to, MLS Number, Address information (number, street, city, county, state, 5 digit or 9 digit zip code), school district, latitude, longitude, number of baths (full, half, quarter, three-quarters or a combination), number of bedrooms, square footage, existence of a family room and/or living room, year built, association fees, a list of bills included in the rent, and a list of included amenities, including air conditioning, heating, water, washer, dryer, trash, electricity, cable, pool, etc. Additional fields may also include how much repair has been done in a property, the kind of upgrades that have been made to a property, what floor an apartment is on, etc. All of these factors may affect rental value and can be considered as factors in one of the models. For example, the floor an apartment is on may affect such factors as what amenities are available to an apartment, how much noise the apartment may receive from other floors or from nearby streets and the outside, etc., all of which may affect rental values. MLSs may provide hundreds, thousands, or even millions of rental records to the data gathering module to be stored in Rental Amounts and Characteristics Data database 101.

Other sources of rental transaction data may be contacted to download either alternate or additional rental information to be stored in the Rental Amounts and Characteristics Data database 101. For example, a variety of websites allow users to directly post a property for rent. These online classified rental listing aggregators can contain rental transaction information from across the US. For example, Craigslist, Vast.com, Oodle.com, rentBits, and Kroobe.com all contain user posted rental listings that may have associated rental prices, and a variety of characteristics associated with the property. These characteristics may include all, a subset, or additional characteristics compared to the MLS listings. All of this information may be downloaded periodically by the data gathering module 112 for storage in the Rental Amounts and Characteristics Data database 101.

In some embodiments, additional sources may be available to populate and/or supplement records in the Rental Amounts and Characteristic Data database 101. For example, a service that provides screening information about possible lessees may also receive and store data pertinent to a rental transaction. During the screening process, a landlord may provide a rental amount that was agreed to by the potential lessee being investigated. Additional information, including various characteristics of the property (such as those associated with the MLS data above) to be leased may also be provided to the service. This makes the service a valuable source of data that can be retrieved by the data gathering module 112 and stored in the Rental Amounts and Characteristics Data database 101. In addition, this site, like the MLS, may provide not only listed rent prices, but actual agreed upon rent prices between lessors and lessees that may be more accurate.

The Rental Amounts and Characteristics Data database 101 may receive and contain rental information, including characteristics of real-estate properties that are associated with either actual or listed rental amounts. This may include any data gathered by the data gathering module 112. This provides a wealth of data for the models disclosed herein to correlate with listed rents. It may be advantageous to use multiple data sources to populate the Rental Amounts and Characteristics Data database 101 in order to provide a near complete coverage of the US (or any specific region's) rental market by using a plurality of the data sources described above. In addition, MLS listings may contain biased rent amount data toward upper end assets relative to direct user posting website listings. This suggests listing/pricing varies due to clientele user affects between the two types of listings, controlling for geography and structure type. Such affects may be corrected by lowering the input rent amounts or the output rental predictions.

In addition to MLS and other third party rental listings, property management companies may be a source of property or rental information. In addition to gathering traditional property information, these companies may have access to other information not listed in an MLS. For example, property management companies often track the amount of inquiries they receive to rent properties, the amount of properties actually rented out, the prices of those properties, the maintenance performed on those properties, the amount of people leasing through those property management companies, and the rent amounts individuals are willing to pay for those properties, among other information.

The data gathering module may also collect other auxiliary type data, such as market trend data from a variety of other sources. These sources are usually, but not necessarily, auxiliary data points associated with a location identifier.

By way of example, the Department of Housing and Urban development provides fair market rent estimates for at least 530 metropolitan areas and at least 2,045 non-metropolitan county areas that are throughout the United States. This data may correspond to the rate of a house in the 50th percentile of a particular geographic location, such as by zip code. This data may be downloaded from the HUD's website, for example, from http://www.huduser.org/portal/datasets/fmr.html. The data gathering module may, periodically (i.e. weekly, monthly, quarterly, etc.) download this information, perform some parsing and/or manipulations on the data, and store it in a database containing local HUD data 104. This data, like all other data gathered by the data gathering module, may be downloaded from the data authority's (e.g. the government here) website, web service, FTP site, or other online data publishing methodology. In some embodiments, a third party supplier of the data might act as an intermediary, and may provide the data for download instead. As yet another alternative, the data gathering module may, instead of “pulling” the data from a source, may instead receive a “push” type data transfer from a data source.

As another example, a data source may contain information about real-estate foreclosures and their corresponding addresses, or the number of foreclosures occurring within a zip code during a certain time period. Similarly, a data source may contain information about real estate defaults by zip code, or those properties that have received a notice of default, along with the properties' address information (or summarized by zip code).

Other data that may be collected in order to assess and model its impact on rental amounts. Employment data may be collected from government agencies or private third parties tracking such information. In particular, the employment rate and employment rate trends may be collected, particularly if associated with a geographic location such as a zip code. Demographic information may also be collected about a particular area or zip code. For example, it may be useful to collect the working ages or average working age of any area, or the national origin makeup of an area. Education level of an area may also be collected as it may have an impact on rental value. This may include collecting information on the popularity of high school, undergrad, and graduate education, the specific types of education (popularity of sciences, engineering vs. liberal arts degrees, etc.), average test scores for elementary, junior high and high schools, and or school ratings for an area. The rate of building permit issuance may also be a factor that correlate with rental value and may be collected. For example, an increase in building permits may indicate a lack of current supply of rental properties in the area, where a decrease in building permits may indicate too much supply of rental properties on the market (which may affect rental price). Information may also be collected about non-rentals. For example, collecting information about non-rentals may allow a ratio to be calculated of rental properties to non-rental properties. This ratio may have a correlation with rental price. These may all be collected by the data gathering module 112, and stored, by way of example, in the market trends and other auxiliary data database 107.

Other information may be collected about geographic areas which may impact rental price. These include the relative weather in an area, such as the average temperature, amount of rainfall per year, the distance from an ocean or lake, the amount of traffic that occurs in an area, and which companies are the major employers or are headquartered in an area.

As another example, a data source may contain information about vacancy rates associated with geographic locations such as zip codes. Such information may be downloaded from the US government using US census data, and updated periodically. This information may be collected by the data gathering module 112, and stored, by way of example, in the Vacancy Data database 103.

Similarly, the data gathering module may also collect output from AVMs that may be used to detect correlations between estimated sale prices with rental prices. For example, as described previously, AVMs may predict the sales price of a real estate property. By calculating the predicted sales price for each property, this prediction can then be used as an input to train a regression model, including the models disclosed herein. For example, an AVM may periodically predict sales prices for all or a subset of real estate properties in an area. These data points may then be summarized by zip code or other geographic region. The raw and/or summarized data may then be stored within the AVM Values database 106 for use by the Rent Prediction System 113 in making correlations.

Other information may also be gathered, by the data gathering module, from a variety of data sources and stored in databases 101-107, including average income per zip code which may be stored in Income Data database 105, the average price per square foot per zip code, or the average sell price. This data may also be calculated using the rental information, IRS information, bank information, credit bureau information, or from a variety of other sources.

When contacted by the data gathering module, these data sources, whether they are web, FTP, or other network data sources typically transfer data to the data gathering module (sometimes after an authentication, authorization or accounting procedure). In some embodiments, data from any of these data sources need not be imported by the data gathering module electronically, and can instead be received through the mail (or other physical transfer medium) on removable storage. This data can then be inserted into the data gathering module for copying to a database, or loaded directly onto the database itself.

### Validation and Deduplication

The data gathering module, or the databases themselves, may perform data cleaning, standardization, and validation in order to maintain data integrity of the Rental Amounts and Characteristics Data database 101 or any of the auxiliary databases 103-107. This often involves detecting misinformation inserted into the main rental data or the auxiliary data.

For example, in some embodiments, the data gathering module may look for and detect MLS records that are in fact sale listings, but are instead categorized falsely as a rental listing. Failing to detect this type of false listing may mistakenly inflate, by possibly several factors, a rent amount that could affect the accuracy of the rental model. This data can be detected by looking for rental prices that are not within a certain threshold. Other values can also be checked for consistency. For example, a sanity check can be performed to confirm that the number of bedrooms is less than a given threshold (e.g. less than 8 if over 1500 square feet, or less than 5 if less than 1500 square feet). Any records that do not meet these consistency types of checks may be removed from the data sets. Similar checks may be performed for data fields containing property year/year built, number of bathrooms, square feet, number of car spaces, listed rent, landlord email, landlord phone, etc.

Other data standardization and validation checks may include making sure that a full complete address is listed for each property. For example, if a property is missing its street name, street number, or apartment/unit number (if an apartment/multi family unit), the property record may be flagged or deleted from the system.

In some embodiments, rental record data may be validated against loan data. For example, a loan database, such as one that collects information about mortgage on homes or apartments, may contain information about a rental property. Such loan databases collect as a part of the loan process information about the size, location, and amenities of a property. This data may include, by way of example, the square footage of a home, the number of bedrooms, the number of bathrooms, the home's address, among other information. When analyzing a rental record entry, the information in the rental record may be compared with data gathered, if any, by a loan data or loan application database. If values do not match (e.g. the square footage of the rental record does not match the square footage of the loan application record), then the data gathering module may flag these rental records as potentially un-validated. The system may then take some corrective action, such as adopting the loan information value (e.g. the loan application's square footage for the property), or remove the rental record, or mark it to not be used for any prediction or model training.

In some embodiments, the system can determine whether to use the loan application value over the rental value by using reasonable common sense bounding of values. For example, if the square footage in the loan application is 2000 for a home, but the same property when listed as a rental has 20,000 square feet, then the system may determine that the square footage is off by a factor of 10, which may be beyond a predetermined threshold for errors. Thus, in some embodiments, the 2000 square footage figure from the loan data may be adopted instead, and replace the value in the rental record.

Gathered rental records may also be checked for duplicates. This can be accomplished in some embodiments by assigning a unique identifier to each record that can be based on a formula that combines characteristics of the properties. For example, the combination of street address, city, state, zip code, latitude, longitude, bedroom count, bathroom count, and square feet may be combined into a unique id. If any two properties have the same ID, further investigation is warranted. For example, the two properties may be duplicate listings, or the two properties may be included within the same multi-family apartment building. Properties that indicate they are multi-family dwellings may be ignored as duplicates, or have the duplicates removed, depending on the emphasis desired in the data records for a single multi family dwelling. The list of duplicates can then be narrowed down further by removing/dropping records for those duplicate properties that were listed on the same date, or within a certain time period of each other. On the other hand, if a duplicate property has two records of list dates approximately 1 year apart (plus or minus a given variance period), it may be assumed by the system that, in the interim, the property was leased, and the latest listing has occurred because a lease was up. In this scenario, both listings may be kept as the previous records help to indicate a historical progression of rental amounts in an area. In some embodiments, other methods of detecting and eliminating duplicates use similar processes, but focus on different date, for example matching record IDs, record expiry dates, or seller/lessor contact information such as an ID, phone number, and/or email address. Auxiliary databases may also be de-duped, typically by removing duplicates records of summary information with the same location (such as zip code), or through another indication that a duplicate has occurred.

The system may track the reliability of each data source, and how many errors were detected in each. This may affect a tracked ranking that the system keeps for each data source. Using this information, each data source may be automatically ranked or evaluated based on how reliable a specific data source is. For example, rental records gathered from a specific site, such as Craigslist, may be less reliable than an MLS. Therefore, the data that may be used as an input to train the model may be weighted so that more reliable data sources have a greater impact on the model, and less reliable data sources have a lower impact on the model.

In addition, multiple models may be trained based on using different data source weights during training. Thus, when a user is requesting a rental value prediction for one or more rental properties, a user may be able to rank the various data sources themselves based on their preferences and how much they trust each data source. This ranking may then determine which models may be used to generate the prediction. For example, a user may rank MLS sources as the most trusted, followed by Craigslist and Oodle.com, in that order. The system may then choose an appropriate model based on that ranking selection made by the user to calculate the rent prediction. Corresponding error models may also be trained and specified based on these ranking/preferences. In some embodiments, instead of assigning rankings, the user may assign weights to each data source. Then, the output (i.e. predictions) from models associated with those data sources may also be ranked accordingly before sent to the user.

In some embodiments, the automatic measure of reliability of a data source may also be used to resolve conflicts. For example, if one data source is more error prone, (for example, Craigslist), but another data source has been tracked to show that it has less errors (for example loan applications for when a property is mortgaged), then the less error prone version's data may be adopted for a specific record for the same property when the two conflict. As one skilled in the art would recognize, similar conflict resolutions may be implemented in other embodiments through the use of weightings or ranked lists.

Smoothing and/or Summarizing Rental Data

The data sources listed above often include only information about individual real estate properties, and do not summarize or average any of the information according to geographic location. The smoothing module 111 may access the data stored in the Rental Amounts and Characteristics Data database 101 and hierarchically “smooth” the data across geography. Smoothing allows the national model to make predictions for properties located in areas where there are few or little comparative properties. Using this method, the RAM may be able to make a rental prediction covering near 100% of United States properties (or 100% of any other geographic region).

Geographic smoothing involves weighting relative geographic averages of property statistics data at a specific level of detail, in order to determine a smoothed average version of the data. For example, if the value of a “Rent Amount” is to be smoothed across a geographical area such as zip codes, an average non-smoothed value of “Rent Amount” can be calculated for all properties at a certain zip code level. So, for example, the smoothing module 111 may calculate the non-smoothed average rent amount for all single family home properties with 1500-1600 square feet within the 92722 zip code. This is a non-smoothed “zip level 5” value (V_{L5}). It may also calculate the same non-smoothed average value for all single family home properties with 1500-1600 square feet within zip codes that start with 9272 (V_{L4}). This would be considered the “zip level 4” value. Similar calculations may be made for all zip levels, including zip codes starting with 927 (level 3, (V_{L3})), 92 (level 2, (V_{L2})), 9 (level 1, (V_{L1})), and all zip codes (level 0, (V_{L0})). Using these values, the following formula (and variations thereof) may be used to calculate the smoother version at a certain level of granularity (F_{Lx}).

F_{L2}=a_{L2}V_{L2}+(1−a_{L2})V_{L1}

where F_{L2} is the estimated rent amount for this category at level 2,

$${a}_{L 2} = \frac{{C}_{L 2}}{k + {C}_{L 2}} ,$$

V_{L2} is the non-smoothed average value for level 2, V_{L1} is the smoothed average value for level 1, and C_{L2} is the total number of properties at that level fitting the category. Thus, in some embodiments, k can be increased to weight the smoothed value at a certain level more towards the average in the coarser level, and decreasing the k value can emphasize the data at the current level. In this example, the smoothed averages are weighted using the current level, and only one coarser level. However, as this is a weighted average, one skilled in the art will realize that the above equations are representative, and similar equations can be used in other embodiments that include more than one level of coarser weights to determine a smoothed average. In this manner, a smoothed zip level 5 (“Zip5”) average may be calculated for rental amounts, as well as for other inputs to the RAM.

The results of smoothing the rental data may be stored in the Smoothed Rent Amounts and Characteristics Data database 102, which may be used as an input to the Rent Prediction System 113 explained herein. Such smoothing may be performed periodically (weekly, monthly, quarterly, etc.), or before each time a RAM is trained with smoothed data.

Data in the other databases 103-107 may also be smoothed and/or summarized in the same manner by the smoothing module 111, if the raw data acquired from online data resources 120 were not summarized by geographic location (e.g. zip code). For example, if notice of default data was downloaded in a format that specified the exact properties that received a notice of default, average notices of default per zip code may be calculated using the specific raw data and the result can be stored in database 107.

### Rent Prediction System

In some embodiments, a rent prediction system uses the inputs stored in databases 101-107, derives and stores derivative rental data characteristics as inputs, trains various RAMs, accepts user input, uses one or more trained RAMS to produce a rental estimate, one or more comps, and an error level (e.g. confidence score) for one or more subject properties.

For example, Derivative Characteristics Module 114 may, if necessary, read inputs from databases 101-107 and transform the data into information useful for training the models implemented by the Rent Amount Prediction Module 118 and the Error Prediction Module 117, or for use in the Comparables Module 116. These values may be stored, in some embodiments, in the Derivative Characteristics database 115 for easy access by modules 116, 117, and 118, or stored in databases 101-107.

Similarly, the Derivative Characteristics module may calculate information that is based on the subject property inputs 110, sent by users from client computing devices 108, for which rents are to be estimated. These derivative variables about the subject properties may also be stored in the Derivative Characteristics database 115, and accessed by modules 116, 117, and 118 to make rental predictions. Examples of derivative characteristics used in some embodiments are described along with examples of how they are used by modules 116, 117, and 118.

The outputs of the Rent Amount Prediction Module 118, Error Prediction Module 117, and/or Comparables Module 116 may be combined to either improve either the model's accuracy, or to give more information and context to the output of a single module. For example, in some embodiments, comps found by the Comparables Module 116 may be used by the Reporting and Interface Module 119 to supplement a rental prediction and error prediction produced by the Rent Amount Prediction Module 118 and Error Prediction Module 117 respectively. The combined output would then be sent to a user device 108 by the Reporting and Interface Module 119.

In some embodiments, the outputs for the prediction of the rent price based by the Comparables Module 116 and the Rent Amount Prediction Module 118 may be weighted depending on the amount of comps found in a specific area. If fewer comps are found or if the standard of deviation/error for the comps model is higher, the system may weight the Rent Amount Prediction Module's 118 rent estimate as a higher weight, and average that with a lower weight prediction from the Comparables Module 116. If many comps are found or if the standard of deviation/error for the comps model is lower, the system may weight the Comparables Module 116 rent prediction as a higher weight, and average that with a lower weight prediction from the Rent Amount Prediction Module 118.

### Rent Amount Prediction Module

The advantage of the rent prediction model implemented by the Rent Amount Prediction Module 118 is that it relies on nationwide data and does not require a large density of comps to accurately predict an estimate of rent.

The Rent Amount Prediction Module 118 may use a nonlinear regression model trained using a gradient descent boosting tree algorithm. Gradient boosting is a machine learning algorithm that is useful for solving regression problems. It produces a prediction model in the form of a collection of weak prediction models, such as decision trees. The algorithm builds the model in stages, and generalizes each stage by allowing optimization of a differentiable loss function. The method tries to, in each stage, find an approximation that minimizes the average value of the loss function on a training set of data. It does so by starting the model with a constant function, and incrementally expanding the model in a greedy fashion.

Such an algorithm may be represented by the equation:

P=F₀+B₁*T₁(X)+B₂*T₂(X)+ . . . +Bₙ*Tₙ(X)

where P is the predicted rent for a subject property, F₀ is the starting value for the series (i.e. mean target value for a regression model), X is a vector containing variables used in the model, T₁(X), T₂(X) . . . Tₙ(X) are small trees fitted to the pseudo-residuals at each stage and B₁, B₂ . . . Bₙ etc. are coefficients of the tree node predicted values.

A gradient descent boosting tree algorithm can be configured with a number of parameters, including the number of trees to use, the learning rate, the number of nodes per tree, the minimum children for each tree, and which loss function to use. In some embodiments, these parameters may be configured as: number of trees=2000, learning rate=0.05, number of terminal nodes=8, minimum children for each tree=200, loss function=least absolute deviation.

The Rent Amount Prediction Module 118 optimizes its model based on various kinds of variables computed from, and stored within databases 101-107, including (1) property variables, (2) localized summary variables, (3) AVM variables, (4) vacancy variables and (5) market trend variables. Many of these variables, such as localized summary variables, AVM variables, vacancy variables, and market trend variables are associated with geographic regions such as zip codes.

The boosting tree algorithm selects these variables based on error reduction from a cut on given variables. The most important variable gives the largest error reduction in regression to the target value, and selection progresses in a greedy fashion. The algorithm iterates through each of the feature subsets, and measures the predictive performance of that subset by the amount of prediction error it reduces through an optimal splitting point. It picks the feature that gives the largest error reduction. This process, called training the model, is repeated until the number of nodes reaches the maximum number given by the user or the error measurement (loss function) converges. In this manner, the gradient boosting decision tree algorithm builds a series of small decision trees sequentially based on the variables calculated for all the rent properties being used as training properties. The next tree is based on the residual of the existing trees. The importance of each variable is based on the overall contribution to error reduction across all decision trees.

The variables, also known as feature characteristics, described above may be derived by the derivative characteristics module 114 and stored in the derivative characteristics database 115, or any other data storage accessible by the Rent Amount Prediction module 118. These variables may be calculated specifically for a certain property, or may be useful to define rental data that is associated with one or more properties' location (e.g. zip code). For example, feature characteristics may be calculated on a per zip code basis (or various zip code levels), where the feature characteristics comprise average rent amounts summarized and/or smoothed over characteristics of properties (e.g. square footage, square footage category (i.e. intervals of square footages), number of bedrooms, number of bathrooms, etc.). Below is a list of example variables, derived or raw, that may be used in some embodiments, calculated over each rental property in the database (for model creation and training purposes), or for each subject property (for use when the model is used for predictions):

Weighted average rent amount by square footage category and property type in the
previous year for property zip code (zip level 5)
Weighted average rent amount by number of beds and property type in the previous
year for property zip code (zip level 5)
Weighted average rent amount by number of baths and property type in the previous
year for property zip code (zip level 5)
Average AVM value for a property, where different AVMs are weighted by
confidence score and FSD
Deviation of AVM value for a property from zip5 level median sales amount
Maximum and minimum values for a property predicted out of all AVM models
Number of property square feet per bed
Square footage of a property
Number of bath rooms
HUD median rent amount for the FIPS area the property is in and same number of beds
Weighted average rent amount by square foot category, property type, and list season,
within zip codes starting with the same 3 digits of the property (zip level 3)
HUD median rent amount for the state the property is in
National maximum, mean, and minimum of rent amounts for the same number of
baths and same type of property in the previously year based on zip level 5 data
Weighted average rent amount by baths, property type, and list season, within zip
codes starting with the same 3 digits of the property (zip level 3)
Total vacancy divided by total property count in the previous year for property zip
code (zip level 5)
Weighted average rent amount by beds, property type, and list season, within zip
codes starting with the same 3 digits of the property (zip level 3)
National mean rent amount for the same number of beds, property type and list
season as the property in the previous year calculated based on zip level 3 data
Median monthly income in the previous year for the property's zip code (zip level 5)
The difference of the notice of default percentage for the local property's zip code
(zip level 5) from the notice of default percentage nationally, divided by the national
notice of default percentage for the previous quarter.
Weighted average of rent amount by square footage category and property type in the
previous year for property zip code (zip level 5) minus the national minimum for the
same square footage category and property type over all zip codes, divided by the
national range for the same square footage category and property type.
Price per square foot of the property minus the national average price per square foot,
divided by the national price per square foot in the same quarter of the previous year,
multiplied by 100.
Weighted average rent amount by number of baths and property type in the previous
year for property zip code (zip level 5)/per square foot.
Median sales price for the zip code of a property at a given year and quarter (zip level
5)
Number of beds + number of baths for the property
At least one AVM model's confidence score for the property

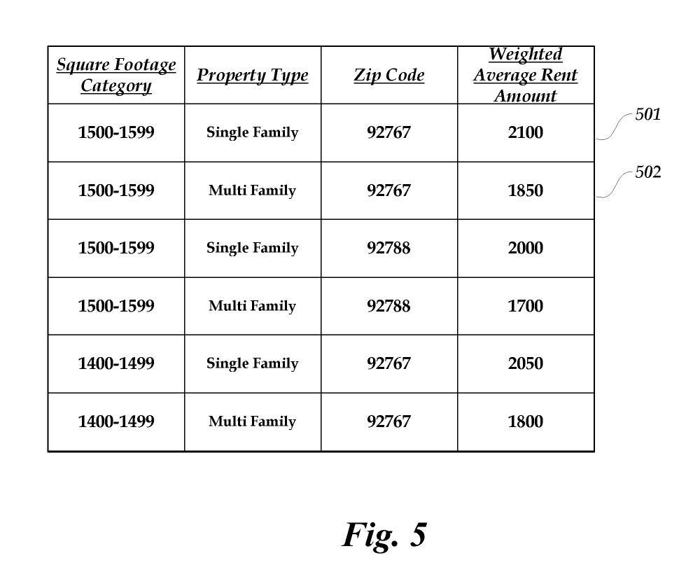

For those data points that are associated with a property by its location (e.g. an average rent amount for specific properties in a zip code) and not per se specific to a particular property, those may all be pre-generated by the derivative characteristics module and placed in a table or other data structure organized by zip code, beds, square footage category, etc. For example, FIG. 5 is an example of pre-generated values associated with the variable “Weighted average rent amount by square footage category and property type in the previous year for property zip code (zip level 5).” It contains a collection of values, where the weighted average rent amount was computed and stored in association with a square footage category, property type, and zip code. For example, row 501 lists a square footage category, 1500-1599 square feet, a property type, “single family”, a 5 digit zip code, 92767, and an associated weight average rent amount calculated over properties listed in the Smoothed Rent Amounts and Characteristics Data 102. Alternatively, this summarized data need not be smoothed. This type of derivative data may be calculated by the Derivative Characteristics Module 114 and stored in the Derivative Characteristics database 115 for use by the Rent Amount Prediction Module 118.

The above list of information used as variables in the model are only representative, and other combinations of data may be used, including any of the auxiliary data source mentioned previously. This includes summaries of geographic information including employment data and trends (such as employment rate in an area and the types of large employers in the area), educational level, reputation of K-12 school systems, the areas rate of granting building permits, the ratio of apartments to single family homes, the amount of upgrades in homes/apartments in the area, the floors apartments are usually on, the weather in the area, the frequency and severity of traffic in the region, the amount of rental inquiries made in the region, the amount of maintenance require to run apartments/homes in the area, and the price differences in the area between a listed/requested rent price and an actual rent price.

Once the required variables have been calculated for all properties in the database, the model may be trained by applying the gradient tree boosting algorithm to these properties and their associated variables described above. For example, in embodiments where the maximum number of specified trees is 2000 each having 8 nodes, the final model will consisted of 2000 small regression trees, where each tree (T(X)) has 8 nodes. In other words,

P=F₀+B₁*T₁(X)+B₂*T₂(X)+ . . . +B₂₀₀₀*T₂₀₀₀(X)

Not all of the properties in database 102 are needed to create the model. One way to test is to set aside a small percentage of the properties, for example 25%, to use as test properties instead of training properties. These properties may then be treated as subject properties, where the model will predict, by executing the equation above, a rent amount using the subject properties derived variables/characteristics. Because these properties also have known rents associated with them, the model can be validated based on the difference between a predicted rent for these properties, and a known rent for these properties. The following error rates may be calculated, such as mean of errors, absolute errors, percent of estimate with error less than +/−10%, percent of estimate with error less than +/−20%, and error in absolute form. By determining these error rates for specific geographic regions, when a subject property's rent is predicted using the comps based model, a confidence score may be associated with the prediction based on the error rate of the subject property's geographic location or property type. For example, in one test of the model, the median absolute error was 9.7% on a hold-out test set.

### Error Module

The Error Prediction Module 117 is a module that may be used to calculate/predict errors of the Rent Amount Prediction Module 118. One measurement of error for a prediction model is the Forecast Standard Deviation (FSD). FSD is a statistical measure that represents the probability that the estimated value produced by the Rent Amount Prediction Module 118 falls within a particular range of the actual rent amount. For example, if the FSD for a model estimate is 10%, there is a 68% (one standard deviation) probability that the true rent amount will fall between +/−10% of the prediction.

The Error Prediction Module 117 may use a similar method as the Rent Amount Prediction Module 118 to calculate an error value. For example, in some embodiments, the module may execute a similar nonlinear regression model using gradient boosting decision tree approach by minimizing a loss function. Instead of the rent amount as the “predicted” dependent variable, the “predicted” dependent variable is the absolute value of the percentage error of the Rent Amount Prediction Module's estimate versus the future actual value of the rent. The Error Prediction Module 117 takes the predicted rent amount plus other property-level variables as independent variables, and uses the properties (and their derived variables/characteristics discussed below) stored in database 101 and 102 as training properties. This can be generalized by the equation:

E=F₀+B₁*T₁(X)+B₂*T₂(X)+ . . . +Bₙ*Tₙ(X)

where E is the absolute value of the percentage error of the Rent Amount Prediction Module's estimate versus the future actual value of the rent for a subject property, F₀ is the starting value for the series (i.e. mean target value for a regression model), X is a vector of independent variables used in this model, T₁(X), T₂(X) . . . Tₙ(X) are small trees fitted to the pseudo-residuals at each stage and B₁, B₂ . . . Bₙ etc. are coefficients of the tree node predicted values.

Because the error in rental prediction by the Rent Amount Prediction Module 118 may be due to a variety of factors, different sets of variables/characteristics may be calculated to characterize the potential reasons of discrepancy between the predicted rent amount and the true rent amount. These variables can be classified in the following categories: (1) ZIP-level summary variables, (2) rent amount estimated from the Rent Amount model, and (3) property characteristics. Examples of these variables are listed below:

Minimum of percentage deviation of predicted rent amount from true rent amount in the
same ZIP code as property.
25 percentile of percentage deviation of predicted rent amount from true rent amount in the
same ZIP code as property.
Median of percentage deviation of predicted rent amount from true rent amount in the same
ZIP code as property.
Mean of percentage deviation of predicted rent amount from true rent amount in the same
ZIP code as property.
75 percentile of percentage deviation of predicted rent amount from true rent amount in the
same ZIP code as property
Maximum of percentage deviation of predicted rent amount from true rent amount in the
same ZIP code as property
Listing count in same ZIP code as property
Minimum of number of bed rooms in the same ZIP code as property
25 percentile of number of bed rooms in the same ZIP code as property
Median of number of bed rooms in the same ZIP code as property
Mean of number of bed rooms in the same ZIP code as property
75 percentile of number of bed rooms in the same ZIP code as property
Maximum of number of bed rooms in the same ZIP code as property
Minimum of deviation of the predicted rent amount from HUD median in property's zip code
25 percentile of deviation of the predicted rent amount from HUD median in property's zip
code
Median of deviation of the predicted rent amount from HUD median in property's zip code
Mean of deviation of the predicted rent amount from HUD median in property's zip code
75 percentile of deviation of the predicted rent amount from HUD median in property's zip
code
Maximum of deviation of the predicted rent amount from HUD median in property's zip
code
AVM of the property (weighted average of all AVM models)
Predicted rent amount from Rent Amount Prediction Module
Property Type (condo, single family house, etc.)
Square footage of living area
Number of beds rooms
Number of bath rooms

Once the required variables have been calculated for all properties in the database, the model may be trained by applying the gradient tree boosting algorithm to these properties and their associated error variables described above. For example, in embodiments where the maximum number of specified trees is 1999 each having at least 50 nodes, and the loss function is the lease absolute error, the final model will consist of 1999 small regression trees, where each tree (T(X)) has at least 50 nodes. In other words,

E=F₀+B₁*T₁(X)+B₂*T₂(X)+ . . . +B₁₉₉₉*T₁₉₉₉(X)

Once trained, the Error Prediction Module 117 may be tested. Not all of the properties in database 101 or 102 are needed to create the model used by the Error Prediction Module 117. One way to test is to set aside a small percentage of the properties, for example 25%, to use as test properties instead of model training properties. These properties may then be treated as subject properties, where the model will predict, by executing the equation above, an FSD for the property. Because these properties also have known rents and predictions associated with them, the model can be validated based on the known error of the prediction. For example, the model may be tested by calculating the true FSD for all records in the test set having the same predicted FSD. Then, the predicted FSD and the true FSD for each value of predicted FSD can be compared to determine the models accuracy. Using this comparison, the following error rates may be calculated, such as mean of errors, absolute errors, percent of estimate with error less than +/−10%, percent of estimate with error less than +/−20%, and error in absolute form.

After training and optional testing of the model, the model may be executed to predict error. When the model executes, it first predicts the error of each rent amount estimate for each subject property. Once this step is done, the FSD may be calculated based on each percentile of the predicted error. A linear relationship between predicted error and the FSD may then be calculated by linear regression. In some embodiments, instead of FSD, a mean absolute error or basic standard of deviation may be calculated.

Based on the FSD value (or mean absolute error or basic standard of deviation, or any other error measure), a confidence score may be calculated. This confidence score may have a linear or non-linear relationship to the FSD value, and may indicate, for example, on a scale of 1-100 the confidence level of the rental value prediction. The confidence score may be a translation or mapping of FSD values to preconfigured scale. For example, in some embodiments, the system may be configured so that an FSD between 0 and 0.1 may be considered a “high” confidence score, an FSD higher than 0.1 and less than or equal to 0.3 may be a “medium” confidence score, and an FSD above 0.3 may be mapped to a “low” confidence score. In some embodiments, instead of “high”, “medium”, and “low” confidence scores, a mapping using ABCDF, such as the traditional grading scale, may be used, among other similar grading mappings. One advantage of using a mapped confidence score rather than an FSD value is that it may be more easily understood by a consumer or investor using the system.

### Model Training Flow

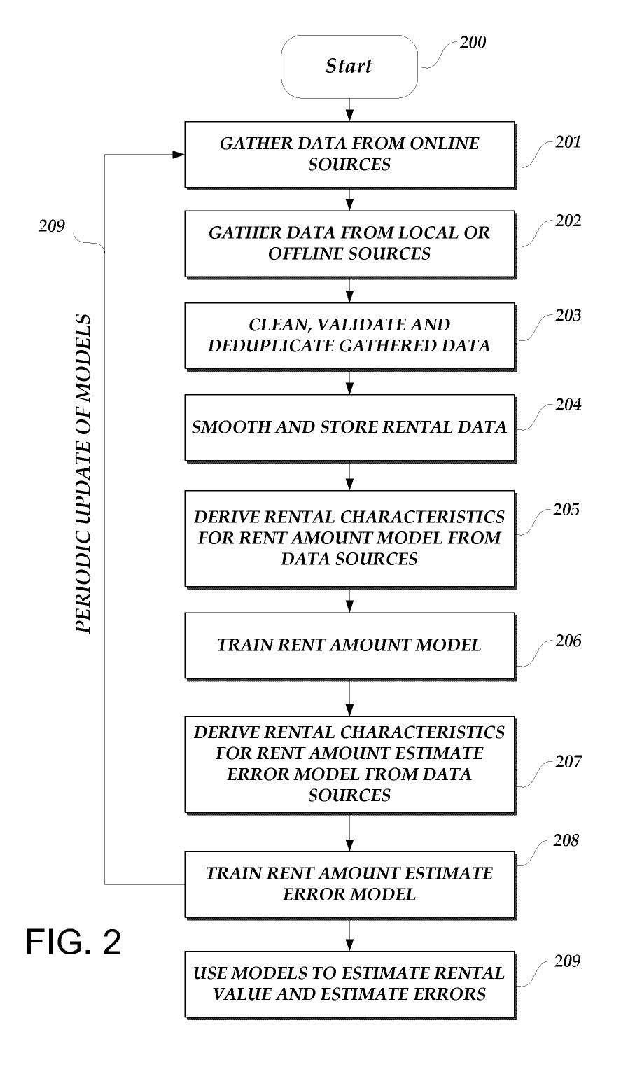

Turning now to FIG. 2, it is a block chart flow diagram that illustrates actions taken by some embodiments to create models that can be used to predict rental value and prediction error. Some embodiments may execute these steps in parallel, or in different orders, taking into account data dependencies.

In block 201, data from online resources are gathered, for example, by the Data Gathering Module 112. This data may be gathered using any methodology known in the art of computer networks, for example, by using web-scraping, web services, APIs, FTP transfers, or batch data transfers, etc. This data may comprise two types of data: rental property data, and auxiliary data. Examples of online data resources 120 containing rental property data include servers owned, operated, or affiliated with MLSs national wide, Craigslist, Vast.com, Oodle.com, rentBits, and Kroobe.com, or any other server or service containing information about rental properties that includes at least a listed or actual rental value associated with the property. In some embodiments, the combined property information may cover an entire geographic area, for example, rental information about locations throughout the United States. Complete or near complete geographic coverage increases accuracy of rental predictions made for properties within the same geographic area. Example data stores 120 of auxiliary information include servers affiliated with the Department of Housing and Urban Development, the US Census, banks, credit bureaus, sales price models, or any other servers containing data about real-estate properties, real-estate market trends, foreclosures, defaults, average rents, vacancies, or income, etc. In

In block 202, the data gathering module 112 may collect information from local networks that are not available to the public. For example, an organization may have internal statistical AVM models that are used to evaluate potential sale prices for real estate properties. The data gathering module 112 may access and query these AVM models to obtain one or more sales price estimates about rental properties in databases 101 and 102. The outputs may be stored in AVM Values database 106, in another data store, or, in other embodiments, queried by either the derivative characteristics module 114, or the rental prediction models, in real-time or as needed. Non-computer methods may also be used to gather either rental property or auxiliary information. For example, one system may receive a disk through postal mail from an authoritative data provider and copy rental property or auxiliary data from the disk to the system's databases.

Once the data has been downloaded and stored in databases 101-107, the data may be cleansed, validated and de-duplicated in block 203. The data gathering module, or the databases themselves, may perform data cleaning, standardization, and validation in order to maintain data integrity of the Rental Amounts and Characteristics Data databases 101 and 102 or any of the auxiliary databases 103-107. This may involve detecting misinformation inserted into the main rental data or the auxiliary data and correcting such information as described elsewhere. In addition, the database may be cleansed of any duplicate records to maintain accuracy by ensuring each property data point only impacts the model once. The process of de-duplication is described elsewhere in the application.

In block 204, as discussed previously in the application, smoothing and summary of the rental data may be performed in order to draw associations about properties located within several levels of geographic location, for example, the 5 different levels of zip codes. Advantageously, this creates a more accurate prediction model by associating a particular property with trends occurring in its local area, and other broader local areas. A more detailed discussion of data smoothing is discussed elsewhere in the application.

In block 205, the derivative characteristics module 114 may calculate derived property variables for each property and store them in the derivative characteristics database 115 for later use by the rent amount prediction module 118. Additionally, the derivative characteristics module may also calculate and derive information across all available properties that may be associated with property features, property location, and various rent amounts. FIG. 5 is an example of values derived across all properties and associated with the variable “Weighted average rent amount by square footage category and property type in the previous year for property zip code (zip level 5)”, one of the many example variables disclosed in previous sections. When properties are being considered by the models, either during training or when executing the model, these calculated variables allows the system to associate average characteristics and rent amounts with specific property features, such as location, square footage, bedrooms, property type, etc. These various combinations of particular property features may be chosen for their heightened impact on average rent amount compared to other combinations.

In block 206, the rent amount model may be trained. For example, the Rent Amount Prediction Module 118 may use the information about the rental properties, and the various calculated variables disclosed above as inputs to the gradient boosting tree algorithm describe herein. This algorithm tries to, in each stage, find an approximation that minimizes the average value of the least absolute deviation from the rent amount. It does so by starting the model with a constant function, and incrementally expanding the model in a greedy fashion, as described herein. The model can be configured with a number of parameters, including the number of trees to use, the learning rate, the number of nodes per tree, the minimum children for each tree, and which loss function to use. Once this process is complete (and any optional validation testing is performed), the model is considered trained and is ready to predict rent amounts for subject input properties.

In block 207, similar to block 205, the derivative characteristics module 114 may calculate derived property variables for each property related to prediction error, including variables derived from executing the rent amount model on the training set of properties to determine the national model's predicted rent amount for that property. Additionally, the derivative characteristics module may also calculate and derive information across all available properties that may be associated with property features, property location, and various rent amounts, such as the predicted rent amount.

In block 208, the rent amount model estimate error model may be trained. For example, the Rent Amount Prediction Module 118 may use the information about the rental properties, and the various calculated variables disclosed above as inputs to the gradient boosting tree algorithm describe herein. This algorithm tries to, in each stage, find an approximation that minimizes the least absolute error between the predicted rent amount and the actual rent amount. It does so by starting the model with a constant function, and incrementally expanding the model in a greedy fashion, as described herein. The model can be configured with a number of parameters, including the number of trees to use, the learning rate, the number of nodes per tree, the minimum children for each tree, and which loss function to use. Once this process is complete (and any optional validation testing is performed), the model is considered trained and is ready to predict rent amounts errors for subject input properties.

Because new rental data becomes available overtime, and rental markets change, it may be advantageous to update the model periodically to increase accuracy. In 209, the trained versions of the rental and error models may be updated and/or recreated with new rental property information. This may occur on a monthly, weekly, nightly, yearly, semi-annually, or quarterly basis, or by any other period.

### Comparables Module

Returning to FIG. 1, in some embodiments, the Comparables Module 116 will make a rental prediction for one or more subject properties, and/or select a number of comparable properties for each subject property by using a comps-based model. A comps-based model may use an appraiser emulation method to estimate the rent price of the subject property. The model may assume the rent price of target property will be affected by property location, physical attributes, and the current time national and local economic environment. This can be generalized as, R(i,t)=f(x(i), l, e); (i.e. rent of property i at time t is affected by physical attributes of vector x, the location l and economic situation e). While the components of location and economic environment may be difficult to quantify and estimate in some cases, they are nearly identical to the same neighbor properties and reflected in the current market rent price. Thus, one natural way to estimate the subject price will be using the current rent price of comparative properties. For example, this can be represented as:

$$R ( s ) = {\sum }_{i = 1}^{n} {w}_{i} * {r}_{i} ( adj )$$

Where R(s) is the estimated rent price for property s; Wᵢ is the weight of the ith comp; rᵢ(adj) is the adjusted rent of the ith comp. In the formula, there are three unknowns, for example, the number of comparable properties (n), the adjusted rent price and the weight.

The comps may be selected on one or more criteria. For example, in one embodiment, three criteria may be used:

(1) The relative distance between comps and subject. For example, in some embodiments, this configurable distance may be set to require a comp to be less than one mile, but may vary based on administrator requirements, or on how dense properties are in a given locale.

(2) Similarity of physical attributes between comps and subject properties. The difference of number of bed rooms, number of bath rooms and living square feet are less than one level. The one level may be defined as one for bed room number, one for a bath room number, and 300 square feet living area. For example, if the subject property's living square feet is 2000, and the living square feet for comps may be within the range of 1700 and 2300 Like relative distances, this configuration may vary based on administrator requirements, or on how dense properties are in a given locale.

(3) Timing. The rent listing date of comps will not be more than one time interval away from the current date. For example, this may be set to one year earlier than target date or later than one day before the target date t-365<τ<t−1. For example, t may be the target date for a rent estimate for subject property sent in from a consumer, τ is the rent listing date of possible comps.

In the Comps model, the selected comps' rental price may be adjusted. The rent list price of comps will be used as a base and adjusted by the difference between a comp's physical attributes and the subject property's physical attributes. The rent price of the property may be decomposed into its physical characteristics to obtain estimates of the contributory value of such characteristic as living square feet, bed and bath rooms. There are multiple ways to estimate the value of physical characteristics which are known in the art, which include at least (1) Hedonic Regression; and (2) a comp based median price method.

Hedonic Regression may be represented by the equation:

y_{i,z}=Σₕ₌₁^{k}B(h)x(ih)+Uᵢ

y_{i,z} may be the log rent price of the ith property in area z, and x(ih) are the log of the hth hedonic variables (bed room number, bath room number and living square feet for ith property), the resulted B(h) may be used to adjust the rent price of the comps according to the difference between comps and subject's hedonic variables.

For the comp based median price method, it may be represented by the equation:

$${v}_{x} = \frac{1}{n} \{ {\sum }_{i = 1}^{n} [ ( {r}_{i} - \overline{r} ) / ( {x}_{i} - \overline{x} ) ] \}$$

where x may be vector of physical features, for example, living square feet, bath room number, bed room number, etc., here r̅ may be the median rent of the comps, and x̅ may be the median value of variable x of the comps, n is the number of comps. If x is living square feet, the value of one unit of living area square feet is computed as the price difference of property from the median price per unit difference of living square feet from median value in the comps. The result vector vₓ will be used to adjust the comps price by the equation:

$${r}_{j} ( adj ) = {r}_{j} + {\sum }_{i = 1}^{m} {v}_{i} * ( {x}_{i , j} - {x}_{i , s} )$$

Where rⱼ(adj) is the adjusted price of comp j, m is the number of features, x_{i,j} is the ith feature of comp j, x_{i,s}, is the ith feature of subject property. The final subject price will be the weighted average of those comps price. All of the data required by either the hedonic method, or the median based method may be calculated by the derivative characteristics module prior to or during comps selection.

$${r}_{jadj} = \begin{matrix}{2}^{( m - 1 )} + {2}^{( m - 2 )} and m is the number of attributes in the model \\ \text{?}\end{matrix} . \\ \text{?} \text{indicates text missing or illegible when filed}$$

The weights wᵢ in the price formula are a measure of general dissimilarity/similarity between comps and subject property and can be represented as the weight score. These weight scores in the expression

$$R ( s ) = {\sum }_{i = 1}^{n} {w}_{i} * {r}_{i} ( adj ) ,$$

are related via the equation:

W_{Score}=W_{Score}+W_{Time}+W_{Dist}+W_{Avm}+W_{Price}+W_{SameStreet}+W_{livingsquarefeet}+W_{BedRooms}+W_{BathRooms}

Where W_{Score} may represent the overall score; W_{Time} may represent the score for time between rent listing date to target date; W_{Dist} may represent the score for distance; W_{AVM} may represent the score for an AVM value; W_{Price} may represent the score for comp adjusted rent price; W_{SameStreet} may represent the score for whether the comp has the same street name as the subject; W livingsquarefeet may represent the score for living square feet; W_{BedRooms} may represent the score for the number of bed rooms; and W_{BathRooms} may represent the score for the number of total rooms.

The Comps model avoids or indirectly solves the some difficult issues in rent estimation—the valuation of location, local economic situation and other unknown rent property demand and supply factors such as population growth, job movement etc. Many of those factors are either difficult to quantify or difficult to find data about such factors. Instead, the comps model can make it easy and clear to show the logic behind the estimate price of the subject and more accurately estimate the individual property's rent if the comps and subject data are accurate.

In some embodiments, the comparables module 116 uses at least the following types of variables about each property: (1) transaction variables such as list date, list price, listing conditions, listing terms and listing property detail address (2) property location variables such as address (including zip), longitude, and latitude; (3) property physical variables such as living square feet, bed rooms, bathrooms, lot size, whether there is a pool, park space, year build, views etc. The comparable modules also uses similar information about one or more subject properties, including (1) subject property location such as address (including zip), longitude, latitude, (2) physical attributes/variables such as living square feet, bed rooms, bathrooms, etc., and (3) a target date used to date the rental prediction.

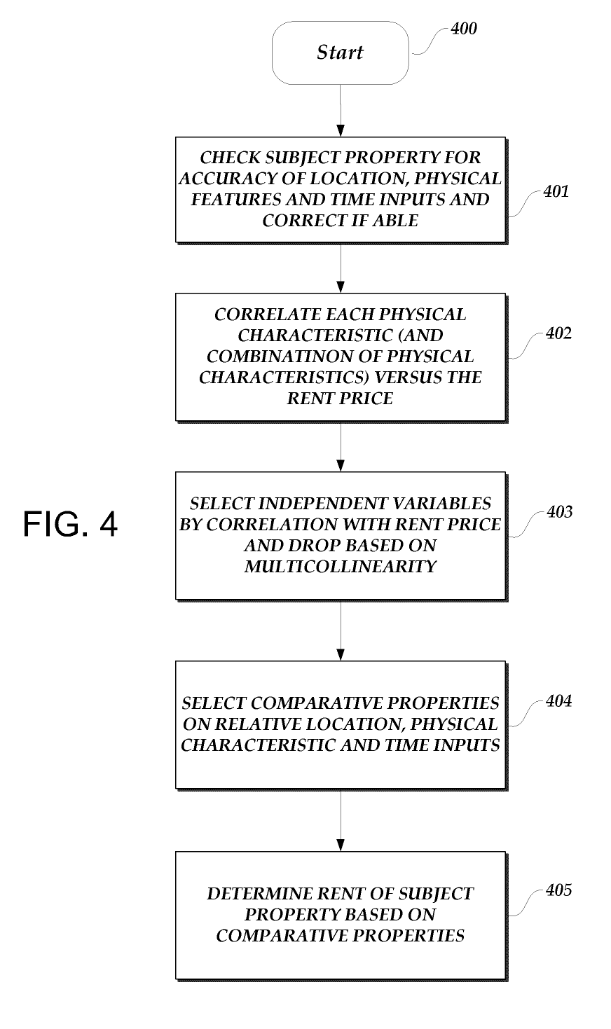

The comparables module 116 may perform any of the foregoing operations, such as those blocks depicted in FIG. 4, in any order so long as one operation is not dependent on another. In block 401, in some embodiments, the comparables selected for a subject property will be checked for the accuracy of location, physical features and time variables. Similarly, each variable in each record entry in the Rental Amounts and Characteristics Data database, the smoothed database 102, or any derived characteristics 115, or any other equivalent database containing information about comparable properties, are checked for (1) frequency, such as how often a particular value occurs, (2) accuracy, such as accurate distribution of variables, and (3) reasonableness (common sense). For example, a comp may be checked for reasonableness by calculating whether “square foot per bedroom” or “square foot per bathrooms” values are above certain thresholds. Any incorrect values and missing values in the location variables may be corrected using mapping information. Otherwise, any records that do not meet this criteria may be dropped from consideration as a comparative property. In addition, these checks need not be performed on all records in such databases. Instead, these may be performed only on records that are located near the subject property.

The comparables module may then, in block 402, calculate the correlation of physical characteristic variables of possible comps versus the rent prices and each other (for multicollinearity). Once tested, in block 403, independent variables may be selected based on its correlation with rent price and dropped because of strong multicollinearity. Each added variable will be tested to see its value in the enhancement of model accuracy (error reduction) and hit rate before being selected for the model by the comparables module 116.

In block 404, once the independent variables are selected, the comps may then be selected on relative location, physical and time variables against the subject properties, as discussed previously herein. The following list of variables, among others, may be calculated and derived by either the derivative characteristics module 114, or the comparables module 116, for each potential comps property and/or subject property, and may be used as selected variables. These variables may then be used to select comps based on whether or not they affect the subject property's rent price significantly.

Estimate price for per 300 square feet
Multiplier for bed rooms
Multiplier for bath rooms
Median rent in the selected comps (useful to compute estimate price of the
component)
Difference from median rent
Median living square feet in the comps
Difference from median square feet
Median number of bed rooms of comps
Difference from median bedrooms
Median number of bath rooms
Difference from median bath rooms
Price per square foot for each bedroom
Price per square foot for each bathroom
Price per square foot for all bedrooms
Price per square foot for all bathrooms
High latitude limit for subject latitude (based on configured distance)
Low latitude limit for subject latitude (based on configured distance)
High longitude limit for subject latitude (based on configured distance)
Low longitude limit for subject latitude (based on configured distance)
Distance between subject and potential comps (can be increased if no
comps found)

After the comps are selected, the comparables module may perform error reduction which may use criteria (μ+/−2.5*σ) as a cut for variables. The 0 value of bedroom, bathroom will be reset as 0.5 etc. The log value of dependent and independent variables may be created and hedonic regression may be performed at the county level. The independent variable will be selected based on correct beta direction and t value. If the comparables module is using the comps median price method, the value of each component may be checked to make sure the right direction and reasonable quantity of value of each component. Then, in block 405, based on each selected property's calculated weight and adjusted rent value, the comparables module 116 may calculate the predicted rent for the subject property as described above.

The model implemented by the comparables module may be tested by calculating the difference of a property's estimated rent in comparison with a known rent (for example, a property that was listed or rented for a certain price). Implementation may use a blind test principal, where any information (i.e. possible comps) that were not available when the property was listed or rented can be ignored. Alternatively, a non-blind test model may also be conducted that uses a full set of properties. Using these tests, error rates may be calculated over particular geographic areas, such as zip codes, counties, states, etc., or for the type of home (single family, multi, etc.), or by any other characteristic. The following error rates may be calculated, such as mean of errors, absolute errors, percent of estimate with error less than +/−10%, percent of estimate with error less than +/−20%, error in absolute form, the standard of deviation, and the forecasting standard deviation (FSD) and percent of estimate with error within range +/− one FSD. By determining these error rates for specific geographic regions, when a subject property's rent is predicted using the comps based model, a confidence score may be associated with the prediction based on the error rate of the subject property's geographic location or property type. Other factors that may also impact a confidence score, such as the number of comps found for a given property.

### Model Execution to Predict Rental Amount and Error Estimates

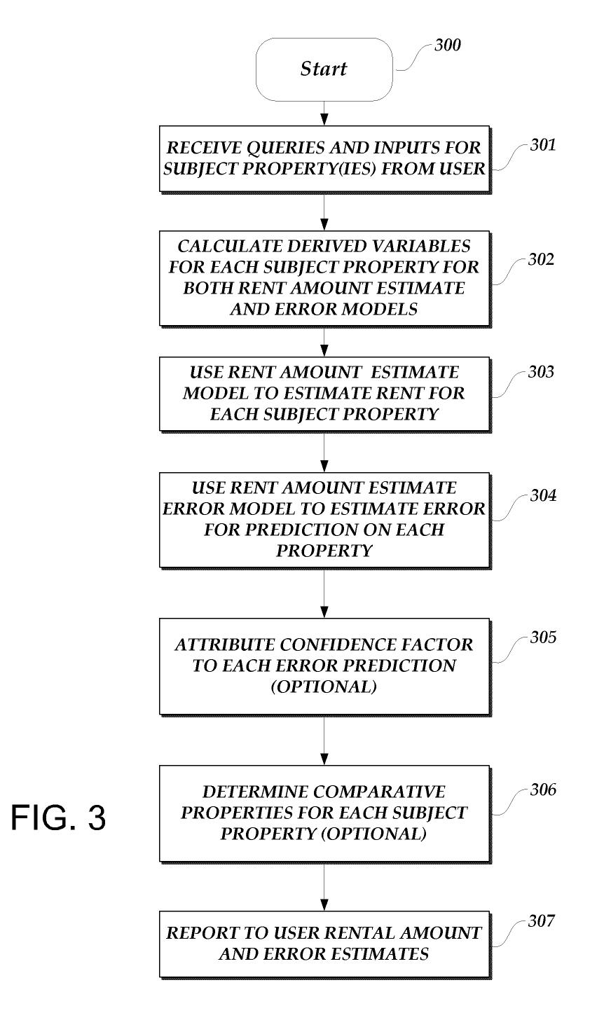

Turning now to FIG. 3, it is a block chart flow diagram that illustrates actions taken by some embodiments to execute models that can be used to predict rental value and prediction error. Some embodiments may execute these steps in parallel, or in different orders, taking into account data dependencies.

In block 301, the system receives rent amount queries about subject properties. These inputs 110, sent electronically, may originate from a client computing device 108, either on a public network 109 such as the Internet, or from a computing device on a local network such as an Intranet. These inputs may be sent directly to an Interface for the Rent Prediction System 113, such as through the Reporting and Interface Module 119, that may comprise a web server or any other network service. The Reporting and Interface Module 119 may send and receive data with a client application, such as a web browser, networked mobile application on iOS or Android, terminal application, or any other custom application.

The inputs comprise information about the one or more subject properties that may be used by the models to estimate rental value and prediction error. For example, the following values 110 about each property may be transmitted to the Rent Prediction System 113:

Description

Full street address including street number, street name,
unit number (if any).
Name of the city.
Name of the state.
5 digit ZIP code.
Number of bedrooms.
Number of bathrooms.
Living area in square feet.
Property Type (single family, condo, etc.)
Year Built

Not all of these values are strictly necessary. For example, the city and state may be calculated based on the zip code, and the year built may not be used by the model. Furthermore, if some data is not available such as the scoring date or year built, the prediction system may still be able to provide a prediction. However, this prediction, depending on the model and its decision trees, may have a larger error than if that data had been provided. This information could be transferred to the prediction system in any form, such as through an HTTP request after filling in a web request form, via API, or be sent in a standard format, such as XML or a tab delimited file.

In block 302, based on the provided information, derived variables may be calculated by the rent prediction system 113. For example, the Derivative Characteristics Module 114, using the subject property inputs and data stored within databases 101-107, may calculate the derived information required for use with executing either the rent prediction model or the error model. For example, both models require a certain set of derived characteristics to execute, that are either derived directly from the subject property(ies)'s inputs, or are associated by location, property type, square footage, number of bathrooms, or any other category that the subject property could fit into. Examples of these variables can be seen in the Rent Amount Prediction Module and Error Module sections, and are related to the same derivative variables that are calculated for model creation.

In some embodiments, many of these variables may have already been created and stored during model creation, and may be referenced again during model execution. For example, the data in FIG. 5 represents sample information that, while associated with properties located in a certain zip code that have a certain square foot range and property type, can be calculated prior to knowledge of the subject property.

In block 303, the trained rent estimate model, such as the one implemented by the Rent Amount Prediction Module 118, executes the model for each subject property using the derived variables and outputs a rent amount prediction for each property, usually in the format of a currency such as the US dollar. The outputs may be in the form of specific rental values, and/or in the form of rental ranges. Such rental ranges may be calculated using, for example, error ranges such as the forecast standard deviation. For example, both $1500 per month, or $1400-$1600 per month are just examples of possible values for the rent amount output. Additional variables that are dependent on the rent amount prediction may be calculated now, as these additional variables may be required to execute the error model.

In block 304, the trained error model, such as the one implemented by the Error Prediction Module 117, executes the model for each subject property using the derived error associated with the error model. The trained error model outputs an estimate of error of the rental prediction, and may comprise an FSD, and/or other error related measurements of the rental estimate. In block 305, based on the output of the error model, the Error Prediction Module 117 may assign a confidence score that is related to the amount of error outputted by the error model.

In block 306, the comps model, such as the one implemented by Comparables Module 116, may be executed to determine a list of comparable properties to each subject property, or in addition, another estimate of rental value or a rental value range based on the comps.

In block 307, all of the outputs, such as the rental value estimates, the error information, confidence score, comps, etc., may be reported back to the device submitting the query via the Reporting and Interface Module 119. This data may be provided in a human consumable visual format, such as HTML, or in a data processing format such as XML, tab delimited files, etc. The data may be sent back to the consumer over network 109 either in real time, or in batch.

### Model Combination

In some embodiments, the national model and the comps model may be combined in order to output a rent estimate based on the rent estimates of both models or the best rent estimate of the two models. After the models have been developed and the rent amount for a subject property has been determined according to each model, the results may be combined in various ways.

In some embodiments, the output of the models may be combined by using an average of the two models with assigned weights. For example, the rent amount of the combined model may be determined by combination equation R_{comb}=wₙₐₜ*Rₙₐₜ+W_{comp}*R_{comp}, where R_{comb} is the combined rent amount, wₙₐₜ is the weight of the national model's output, Rₙₐₜ is the rent amount of from the national model, w_{comp} is the weight of the comps based model's output, and R_{comp} is the rent amount from the comps based model.

In some embodiments, the weights may be calculated based on testing the two models. For example, as explained previously, the collected rent information may be used to test the accuracy of each model. For example, the system may divide the rent information into two subsets, using one set for training the model (or as comps to be selected), and another as a list of test target properties where the estimated rent amount can be compared to the true rent amount associated with the property to determine overall accuracy of the model. In this manner, the system can evaluate the accuracy of each model, and assign a higher weight to a model with a higher accuracy. This process may combine the outputs of two or more models.

In some embodiments, the combination equation may vary depending on the geographic differences of the different models and the location of the subject property. For example, the testing described above may be performed over many different geographic areas, generating a separate combination equation for each area. When determining the combined rent amount estimate of the subject property, the combination equation for the subject property's location may be used. Thus, if the subject property is in a rural area where the comps model may not be as accurate, the selected combination equation may weight the national model more than the comps based model when combining the estimates. Alternatively, in some embodiments, based on the testing described above, only the most accurate model's estimate may be used for a given geographic area.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as the smoothing module 111, derivative characteristics module 114, data gathering module 112, comparables module 116, error prediction module 117, rent amount prediction module 118, and reporting and interface module 119, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 101-107 and 115, relational databases and flat file systems that use magnetic disk storage and/or solid state RAM. Some or all of the components shown in FIG. 1, such as those that are part of the Rent Prediction System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A system for measuring accuracy of an estimate for a rental amount for a real estate property, the system comprising:
non-transitory data storage configured to store rental data associated with a plurality of real estate properties, wherein the rental data comprises at least a location, a rental amount, and a property characteristic associated with each real estate property in the plurality of real estate properties;
a computing system comprising computing hardware configured to communicate with the non-transitory data storage, the computing system configured to store one or more code modules in a memory, the code modules comprising:
a rental amount prediction module configured to predict a rental amount for each real estate property in the plurality of real estate properties based at least in part on the rental data; and
an error prediction module configured to:
receive the predicted rental amounts for each of the real estate properties in the plurality of real estate properties;
determine deviations between predicted rental amounts and actual rental amounts for each of the properties in the plurality of properties;
develop an error model for measuring the accuracy of the rental amount predictions, the error model based at least in part on the stored rental data, the predicted rental amounts, and the deviations between predicted rental amounts and actual rental amounts for each of the properties in the plurality of properties; and
determine, based at least in part on the error model, an error range for rental amount predictions made by the rental amount prediction module.

2. The system of claim 1, wherein the deviations between predicted rental amounts and actual rental amounts for each of the properties in the plurality of properties are averaged over a geographic area to provide geographic-area summary deviations, and the error model is based at least in part on the geographic-area summary deviations.

3. The system of claim 2, wherein the error model is based at least in part on a median of a percentage deviation of predicted rental amount from actual rental amount in a geographic area around each property, an automated valuation model (AVM) estimate of a value for each property, and a living area of each property in the plurality of properties.

4. The system of claim 1, wherein the error model for measuring the accuracy of the rental amount predictions comprises a decision tree model that is trained to minimize a loss function associated with an error in the rental amount prediction.

5. The system of claim 4, wherein the error in the rental amount prediction is an absolute value of a percentage error between the rental amount predicted by the rental amount prediction module and the actual rental amount of the real estate property.

6. The system of claim 1, wherein the error model for measuring the accuracy of the rental amount predictions comprises a nonlinear regression model trained using a gradient descent boosting tree algorithm.

7. The system of claim 1, wherein to develop the error model, the error prediction module is configured to:
train the error model on a first subset of the properties in the plurality of real estate properties; and
test the error model on a second subset of the properties in the plurality of real estate properties.

8. The system of claim 1, wherein the error range comprises a forecast standard deviation (FSD).

9. The system of claim 8, wherein the error prediction module is configured to calculate the FSD based at least in part on percentiles of errors predicted by the error model.

10. The system of claim 8, wherein the error prediction module is configured to determine a linear relationship between the FSD and errors predicted by the error model.

11. The system of claim 8, wherein the error prediction module is configured to map the FSD to a confidence score.

12. The system of claim 1, wherein the error range comprises a confidence score.

13. The system of claim 1, wherein:
the non-transitory data storage is further configured to store non-rental data associated with the plurality of real estate properties, wherein the non-rental data comprises at least one of employment data, market trends data, vacancy data, or income data associated with respective geographic regions associated with each real estate property in the plurality of real estate properties; and
the rental amount prediction module is further configured to predict the rental amount for each real estate property in the plurality of real estate properties based at least in part on the non-rental data.

14. A system for measuring accuracy of an automated valuation for a real estate property, the system comprising:
non-transitory data storage configured to store valuation data associated with a plurality of real estate properties, wherein the valuation data comprises at least a location, a valuation amount, and a property characteristic associated with each real estate property in the plurality of real estate properties;
a computing system comprising computing hardware configured to communicate with the non-transitory data storage, the computing system configured to store one or more code modules in a memory, the code modules comprising:
an error prediction module configured to:
receive an automated valuation amount for each of the real estate properties in the plurality of real estate properties;
determine deviations between the automated valuation amounts and actual valuation amounts for each of the properties in the plurality of properties;
develop an error model for measuring the accuracy of the automated valuation amounts, the error model based at least in part on the stored valuation data, the automated valuation amounts, and the deviations between automated valuation amounts and actual valuations amounts for each of the properties in the plurality of properties; and
determine, based at least in part on the error model, an error range for automated valuation amounts.

15. The system of 14, wherein the deviations between the automated valuation amounts and actual valuation amounts for each of the properties in the plurality of properties are averaged over a geographic area to provide geographic-area summary deviations, and the error model is based at least in part on the geographic-area summary deviations.

16. The system of 14, wherein the error model for measuring the accuracy of the automated valuation amounts comprises a decision tree model.

17. The system of 16, wherein the error model for measuring the accuracy of the automated valuation amounts comprises a nonlinear regression model trained using a gradient descent boosting tree algorithm.

18. The system of 14, wherein the error range comprises a forecast standard deviation (FSD).

19. The system of 14, wherein the error range comprises a confidence score.

20. The system of 14, wherein the automated valuation amount comprises a predicted rental amount.
